(19) United States
(12) Patent Application Publication
(10) Pub. No.: US 2005/0152813 A1
(43) Pub. Date: Jul. 14, 2005

(54) Method of chemical surface modification of polytetrafluoroethylene materials

(76) Inventor: Insup Noh, Gyeonggi-do (KR)

Correspondence Address: PARK & SUTTON LLP, 3255 WILSHIRE BLVD, SUITE 1110, LOS ANGELES, CA, 90010, US

(21) Appl. No.: 10/504,709

(22) PCT Filed: Feb. 19, 2003
(86) PCT No.: PCT/KR03/00338

(30) Foreign Application Priority Data
Feb. 20, 2002 (KR) 10-2002-0008897

(51) Int. Cl. B01J 10/00

(52) U.S. Cl. 422/129; 423/462

(57) ABSTRACT

Disclosed is a method for chemically modifying the surface of polytetrafluoroethylene materials, which allows biocompatibility of the materials to be improved. The method comprises the steps of: mixing a hydrogen compound, such as sodium hydroborate, with a cyclic compound, such as anthraquinone or derivatives thereof, in an organic solvent, such as dichloromethane, so as to produce a reactant solution; adding polytetrafluoroethylene materials, such as ePTFE artificial blood vessels, PTFE films or porous PTFE membranes, to the reactant solution; applying heat or ultraviolet energy to the mixture containing the polytetrafluoroethylene materials, so as to remove fluorine from the surface of the polytetrafluoroethylene materials by electron exchange reaction; removing the remaining reactants from the polytetrafluoroethylene materials; and drying the polytetrafluoroethylene materials. The expanded polytetrafluoroethylene artificial blood vessels and the like, whose surface were modified according to the present invention, have a hydrophilic surface changed from a hydrophobic surface, a remarkably reduced fluorine content, and increased cell adhesion. Furthermore, the surface-modified ePTFE artificial blood vessels may be coated with a biodegradable polymer, such as cell adhesion proteins or polylactide, etc. Also, the surface-modified ePTFE films exhibit remarkably increased permeability.

### TECHNICAL FIELD

The present invention relates in general to a method for chemically modifying the surface of polytetrafluoroethylene (PTEF) materials, which allows biocompatibility of the PTEF materials to be improved. More particularly, the present invention relates to a method for modifying the surface of expanded polytetrafluoroethylene (ePTFE) artificial blood vessels, PTFE films or porous PTFE membranes. Also, the present invention relates to ePTFE artificial blood vessels, PTFE films and porous PTFE membranes, which all have improved biocompatibility.

### BACKGROUND ART

Polytetrafluoroethylenes (hereinafter, also referred to as “PTFE”) are polymer materials with the chemical structure of CF₃—(CF₂—CF₂)ₙ—CF₃.

Expanded polytetrafluoroethylenes (hereinafter, also referred to as ePTFE) are polymer materials having a microporous structure, which are tubular materials used as artificial blood vessels.

Prior ePTFE artificial blood vessels or PTFE films are used as patent's blood vessel- or blood-contacting biomaterials, but after grafting, they cause various side effects due to low biocompatibility. Also, PTFE films or porous PTFE membranes have properties that make them unstable for industrial application.

Thus, there is a need for a method for modifying the surface of the polytetrafluoroethylene materials, which allows the biocompatibility of the materials to be improved.

A prior plasma treatment method for modifying the surface of the expanded polytetrafluoroethylene is a method where ePTFE is introduced into a plasma reactor, which is provided with gas or liquid, and plasma is formed using electricity as an energy source so that the surface of ePTFE is modified with plasma particles having strong reactivity.

However, this method is disadvantageous in that the produced radicals lose their activity in micropores, and thus, the surface of the micropores cannot be modified.

As another surface modification method of the prior art, there is a method using benzophenone or benzoin anions. In this method, fluorine is removed from the surface of ePTFE by means of electron exchange or electron transition, thereby modifying the surface of ePTFE. However, this method is also disadvantageous in that the surface of the micropores cannot be suitably modified.

Meanwhile, Korean Patent Application No. 1991-0000095 (entitled “fluorinated polyurethane with improved bloodcompatibility”) discloses a method for the preparation of modified polyurethane, wherein fluorine compounds are chemically bound to a polyurethane-based polymer so that bloodcompatibility of the polymer is improved.

Korean Patent Application No. 1994-0026594 (entitled “a method for the preparation of modified polytetrafluoroethylenes and the use thereof”) discloses a method for preparing perfluoro-containing tetrafluoroethylene polymers wherein a perfluoroalkyl group has 1-4 carbon atoms. This method comprises polymerizing monomers in an aqueous medium by a suspension polymerization method using a permanganate initiator at a temperature of less than 60° C.

However, there is still a need for an improved surface modification method, by which the biocompatibility of the expanded polytetrafluoroethylene artificial blood vessel, the PTFE film, the porous PTFE membrane or the like is improved.

### DISCLOSURE OF INVENTION

Accordingly, the present invention is has been made to solve the above-mentioned problems occurring in the prior art, and an object of the present invention is to provide a new surface modification method for improving the biocompatibility of the polytetrafluoroethylene materials.

Another object of the present invention is to provide ePTFE artificial blood vessels, PTFE films or porous PTFE membranes, whose surface was modified to have improved biocompatibility.

To achieve the above objects, the present invention provides a method for chemically modifying the surface of polytetrafluoroethylene material, which allows biocompatibility of the materials to be improved.

Specifically, the present invention provides a method for modifying the surface of polytetrafluoroethylene artificial blood vessels, PTFE films or porous PTFE membranes.

Also, the present invention provides ePTFE artificial blood vessels, PTFE films and porous PTFE membranes, which all have improved biocompatibility.

The method for chemically modifying the surface of the polytetrafluoroethylene materials according to the present invention comprises the steps of: mixing a hydrogen compound, such as sodium hydroborate, with a cyclic compound, such as anthraquinone or derivatives thereof, in an organic solvent, such as dichloromethane, so as to produce a reactant solution; adding polytetrafluoroethylene materials, such as ePTFE artificial blood vessels, PTFE films or porous PTFE membranes, to the reactant solution; applying heat or ultraviolet energy to the mixture containing the polytetrafluoroethylene materials, so as to remove fluorine from the surface of the polytetrafluoroethylene materials by electron exchange reaction; removing the remaining reactants from the polytetrafluoroethylene materials; and drying the polytetrafluoroethylene materials.

The surface-modified, expanded polytetrafluoroethylene artificial blood vessels, whose biocompatibility was improved according to according to the present invention, has a hydrophilic surface converted from a hydrophobic surface, a remarkably low fluorine content, and increased cell adhesion.

Also, the surface-modified, ePTFE artificial blood vessels may be coated with biodegradable polymers, such as polylactides or cell adhesion proteins.

Moreover, the surface-modified PTFE films exhibit remarkably increased permeability.

The polytetrafluoroethylene materials with improved biocompatibility according to the present invention are used as a material of stent-bound ePTFE artificial blood vessels, artificial hearts, artificial valves, artificial kidneys, venous catheters, and the like.

Hereinafter, the method for chemically modifying the surface of the polytetrafluoroethylene materials according to the present invention will be described in detail with reference to FIG. 1.

Step 1: Preparation of Reactant Solution

A reactant solution is produced under the atmosphere of inert gas.

In producing the reactant solution, 0.1-1 g of a hydrogen compound, such as sodium hydroborate or sodium hydride, 0.2-2 g of a cyclic compound, such as anthraquinone or derivatives thereof, 10-100 ml of an organic solvent, such as anhydrous dichloromethane, dimethylformamide or dimethylsulfoxide, are introduced into a round flask equipped with a magnetic stirring bar.

Examples of the anthraquinone derivatives, which can be used in the present invention, include aminoanthraquinone, dichloroanthraquinone, anthraquinone carboxylic acid, and anthraquinone disulfonic acid.

In this case, the amounts of the hydrogen compound, the cyclic compound and the organic solvent are by a relative ratio.

The weights of the experimental vessel, the samples and the chemicals are measured under the atmosphere of inert gas.

Water present in the experimental vessel is removed using a hot oven or inert gas.

Step 2: Introduction of Expanded Polytetrafluoroethylene, etc.

Polytetrafluoroethylene materials are introduced into the reactor containing the reactant solution produced in Step 1.

In this case, the polytetrafluoroethylene materials are selected from the group consisting of ePTFE artificial blood vessels, PTFE films and porous PTFE membranes.

Step 3: Setting of Reaction Apparatus

A reaction apparatus is set as shown in FIG. 2.

The reactor 11, which includes the reactant solution containing the expanded polytetrafluoroethylne artificial blood vessels or the like, is connected to the condenser 10, and a hose 14 is connected to a port disposed at the outside of the condenser 10 such that water can be circulated.

A gas line 16, through which inert gas such as nitrogen or argon flows, is connected to the upper portion of the condenser 10 connected to the reactor 11.

The reactor 11 is disposed within the mantle 12, and the reactor set is mounted on the stirrer 13.

The bubbler 20 containing oil 21 is connected to the inert gas line 16.

Inert gas is supplied, covers the reactant solution, and flows in such a manner that the remaining oxygen is removed.

The flow of gas is determined if a drop occurs in the oil 21 contained in the bubbler 20.

Step 4: Energy Supply and Fluorine Removal Reaction

Through the mantle 12 connected to an electrical controller, the reactor 11 is heated to a temperature of 30-300° C. by electric energy so that the reactor 11 is supplied with energy.

Alternatively, the reactor is supplied with radiant energy of a 190-1000 nm wavelength from an UV lamp.

Water 14 is circulated through the condenser 10 so that the reactant solution is refluxed. For this reason, the reactant solution is prevented from evaporation as temperature increases, and reacted with the polytetrafluoroethylene materials while the amount of the reactant solution is maintained at a constant level.

The reactant solution is stirred using the magnetic stirring bar for 1-120 hours depending on the desired degree of surface modification, and at the same time, it is reacted by the supply of energy thereto.

Electron transition between the polytetrafluoroethylene materials and the activated reactants in the reactant solution is induced, so that fluorine is removed from the surface of the polytetrafluoroethylene materials.

Step 5: Removal of Remaining Reactants

After the reaction was carried out for a certain time of period, the energy supply is discontinued and the stirring is stopped.

The reacted polytetrafluoroethylene materials are drawn from the reactor.

The remaining reactants are removed from the polytetrafluoroethylene materials using a mixed solvent of water and an organic solvent, such as chloroform, toluene, benzene and the like.

Step 6: Drying

The polytetrafluoroethylene materials are dried in a vacuum drier at 60° C. for one day.

According to the method as described above, the surface of the polytetrafluoroethylene materials is chemically modified.

### BRIEF DESCRIPTION OF THE DRAWINGS

FIG. 1 is a flow chart illustrating a method for modifying the surface of polytetrafluoroethylene materials according to the present invention;

FIG. 2 schematically shows a reaction apparatus for modifying the surface of polytetrafluoroethylene materials according to the present invention;

FIG. 3 is a photograph showing the surface of an ePTFE artificial blood vessel before surface modification;

FIG. 4 is a photograph showing the surface of an ePTFE artificial blood vessel, which was modified for 24 hours according to the method of the present invention;

FIG. 5 is a photograph showing the surface of an ePTFE artificial blood vessel, which was modified for 72 hours according to the method of the present invention;

FIG. 6 is a drawing showing a chemical analysis result on the surface of an ePTFE artificial blood vessel before surface modification;

FIG. 7 is a drawing showing a chemical analysis result on the surface of an ePTFE artificial blood vessel, which was modified according to the method of the present invention; and

FIG. 8 is a photograph showing the surface of an ePTFE artificial blood vessel coated with a polymer.

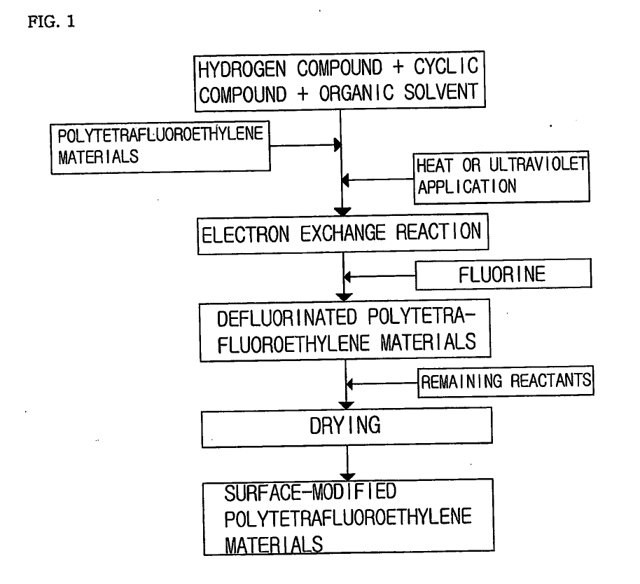

### BEST MODE FOR CARRYING OUT THE INVENTION

The method for chemically modifying the surface of the tetrafluoroethylene materials according to the present invention will now be described in further detail by examples and test examples. It should however be borne in mind that the present invention is not limited to or by the examples and the test examples.

### EXAMPLE 1

### Surface Modification of Expanded Polytetrafluoroethylene Artificial Blood Vessel

0.4 g of sodium hydroborate, 0.8 g of anthraquinone, and 100 ml of anhydrous dimethylformamide were introduced into a 250 ml round flask.

The mixture was stirred using a magnetic stirring bar, thereby producing a reactant solution.

A polytetrafluoroethylene artificial blood vessel of a 5 cm length was introduced in the reactant solution.

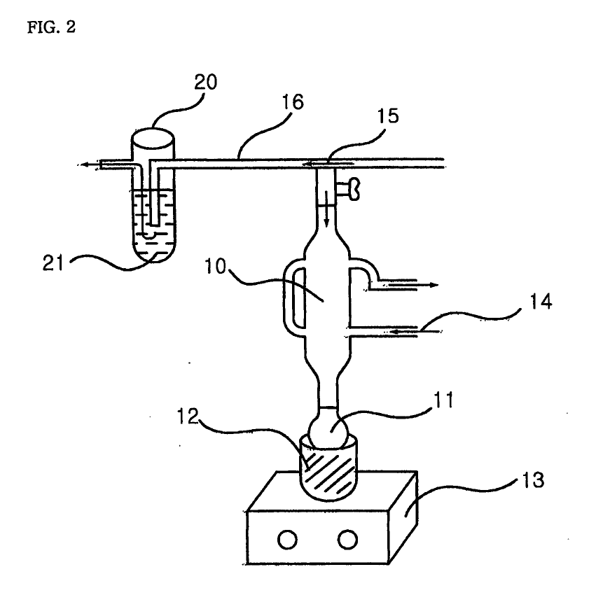

A reaction apparatus was set as shown in FIG. 2.

The round flask containing the reactant solution and the ePTFE artificial blood vessel was connected to a condenser, and a hose was connected to a port disposed at the outside of the condenser such that water could be circulated.

A gas line connected to a nitrogen line was connected to the upper portion of the condenser connected to the round flask. After this, using a mantle and a controller, the reactant solution was electrically heated to 100° C. with nitrogen passed therethrough.

Water was circulated through the condenser, and the reactant solution was reacted with the surface of the ePTEF material for 24 hours while stirring with a stirrer.

After reaction, the ePTEF artificial blood vessel was drawn from the resulting solution.

The remaining reactants were removed from the ePTEF artificial blood vessel using water and chloroform.

The ePTEF artificial blood vessel put in a vacuum drier and dried at 60° C. for 24 hours.

In this way, the surface of the expanded polytetrafluoroethylene artificial blood vessel was modified.

### EXAMPLE 2

### Surface Modification of ePTFE Artificial Blood Vessel for 48 Hours

The surface of an ePTFE artificial blood vessel was modified in the same manner as Example 1 except that the reaction was carried out for 48 hours instead of reacting for 24 hours.

### EXAMPLE 3

### Surface Modification of ePTFE Artificial Blood Vessel for 72 Hours

The surface of an ePTFE artificial blood vessel was modified in the same manner as Example 1 except that the reaction was carried out for 72 hours instead of reacting for 24 hours.

### EXAMPLE 4

### Surface Modification of PTFE Film

The surface of a PTFE film of a 2 cm×2 cm size was modified in the same manner as Example 1 except that the PTFE film was introduced into the reactant solution instead of introducing the expanded polytetrafluoroethylene artificial blood vessel.

### EXAMPLE 5

### Surface Modification of a Porous PTFE Membrane

The surface of a porous PTFE membrane of a 2 cm×2 cm size was modified in the same manner as Example 1 except that the porous PTFE membrane was introduced into the reactant solution instead of introducing the expanded polytetrafluoroethylene artificial blood vessel.

### TEST EXAMPLE 1

### Measurement of Morphological Change According to Surface Modification

Using scanning electron microscopy, the expanded polytetrafluoroethylene artificial blood vessel was examined its morphological change before and after surface modification.

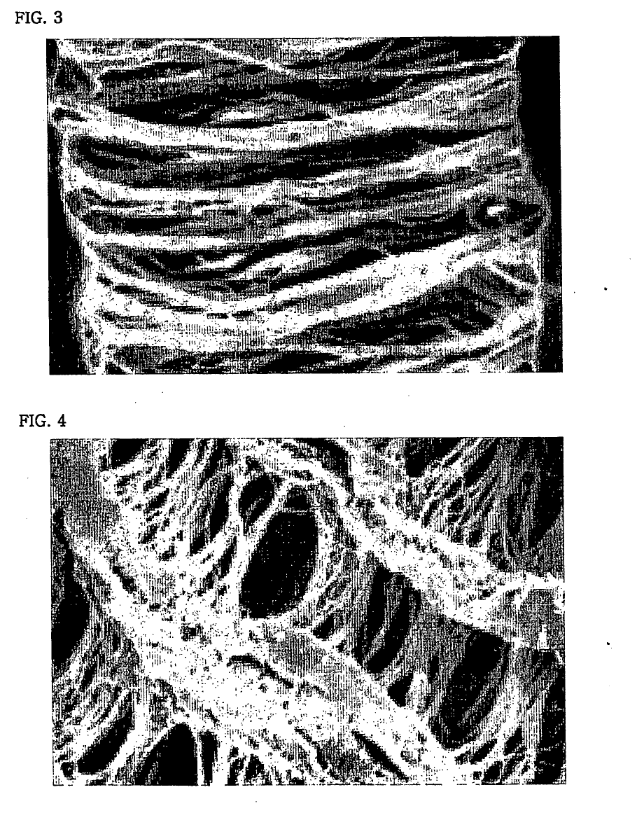

FIG. 3 is a photograph showing the surface of the ePTFE artificial blood vessel before surface modification.

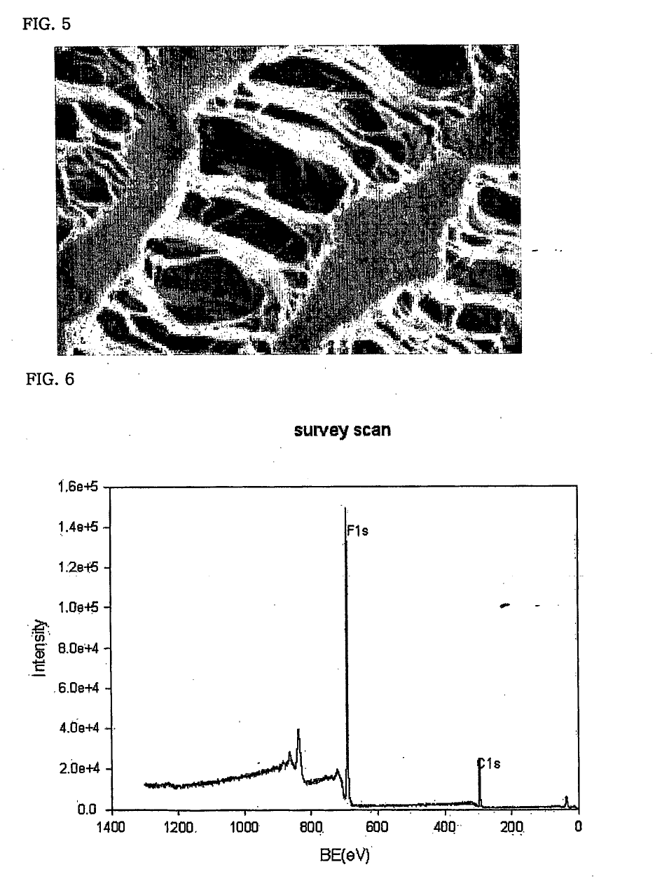

FIG. 4 is a photograph showing the surface of the ePTFE artificial blood vessel, which was modified for 24 hours according to Example 1, and FIG. 5 is a photograph showing the surface of the ePTFE artificial blood vessel, which was modified for 72 hours according to Example 3.

From these photographs, it could be found that the surface of the artificial blood vessel was morphologically changed by the surface modification.

Also, the results of measurement of dynamic water contact angles indicated that a hydrophobic surface (contact angle of 120°) of the artificial blood vessel before surface modification was changed into a hydrophilic surface (contact angle of 20-90°) after surface modification.

### TEST EXAMPLE 2

### Measurement of Change in Fluorine Content of Surface of ePTFE Artificial Blood Vessel According to Surface Modification

Using X-ray electron microscopy, the surface of the ePTFE artificial blood vessel was examined for its fluorine content before and after surface modification.

FIG. 6 is a drawing showing a chemical analysis result on the surface of an ePTFE artificial blood vessel before surface modification. From FIG. 6, it could be found that the surface of the ePTFE artificial blood vessel contained a large amount of fluorine before surface modification.

FIG. 7 is a drawing showing a chemical analysis result on the surface of the ePTFE artificial blood vessel, which was modified for 24 hours according to Example 1. From FIG. 7, it could be found that the amount of fluorine in the chemical structure of CF₃—(CF₂—CF₂)ₙ—CF₃ was reduced and new oxygen was added.

### TEST EXAMPLE 3

### Test of Fibroblast Culture According to Surface Modification

In order to examine biocompatibility of the ePTFE artificial blood vessel before and after surface modification, a test of fibroblast culture was carried out.

In this test, the ePTFE artificial blood vessel before surface modification, and the ePTFE artificial blood vessel, which had been subjected to surface modification according to Example 1, were used.

Fibroblasts (1×10⁶ cells/cm²) were cultured directly or cultured after being adsorbed with cell adhesion proteins such as fibronectins.

As a result, the ePTFE artificial blood vessel before surface modification showed cell adhesion at less than 5% of a surface area thereof. On the other hand, cell adhesion of the ePTFE artificial blood vessel, which had been subjected to surface modification according to Example 1, was remarkably increased. Namely, it exhibited cell adhesion at more than 80% of a surface area thereof.

### TEST EXAMPLE 4

### Test of Formation of Hybrid Artificial Blood Vessel

In this test, the ePTFE artificial blood vessel, which had been subjected to surface modification according to Example 1, was used.

Polylactide as a biodegradable polymer was dissolved in a dichloromethane solvent to produce a 5% solution.

The produced biodegradable polymer solution was coated on the inner and outer portions of the surface-modified ePTFE artificial blood vessel to a 1 mm thickness.

As a result, it was observed with the naked eye that a biodegradable polymer-ePTFE hybrid artificial blood vessel was formed.

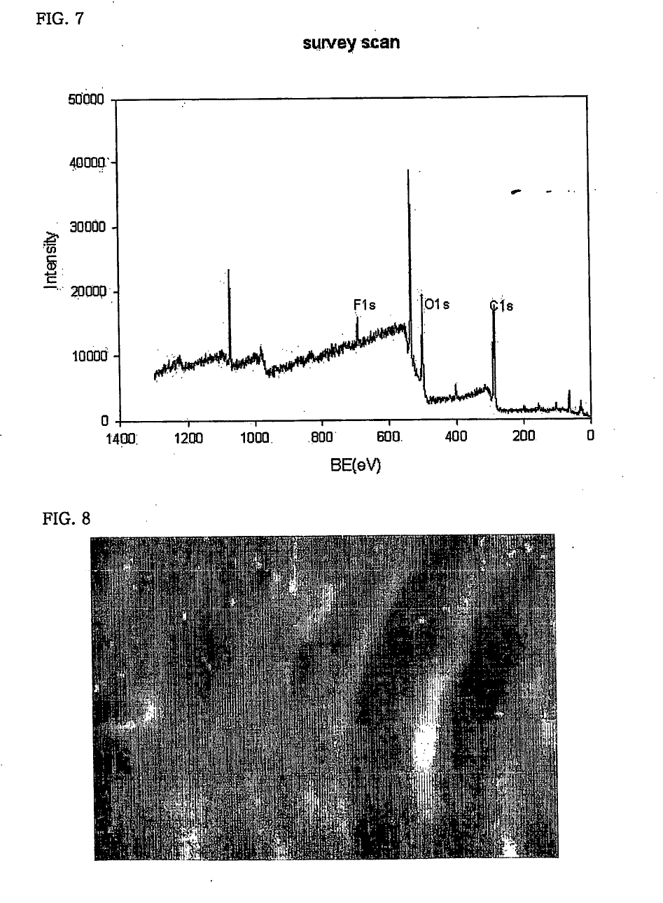

FIG. 8 is a photograph showing the surface of the ePTFE artificial blood vessel coated with the biodegradable polymer.

### TEST EXAMPLE 5

### Measurement of Drug Delivery Using PTFE Film

Using water, heparin and albumin as model drugs, PTFE films before and after surface modification were measured for their drug delivery.

Permeabilities of the PTFE film before surface modification were 104×10⁻⁷ cm/sec, 28×10⁻⁷ cm/sec, and 1.9×10⁻⁷ cm/sec for water, heparin and albumin, respectively.

Permeabilities of the PTFE film, which had been subjected to surface modification according to Example 4, were remarkably increased. Namely, it showed the permeabilities of 168×10⁻⁷ cm/sec, 45×10⁻⁷ cm/sec, and 7.1×10⁻⁷ cm/sec for water, heparin and albumin, respectively.

### Industrial Applicability

As described above, the present invention provides the method for chemically modifying the surface of the PTFE materials, such as expanded polytetrafluoroethylene artificial blood vessels, PTFE films and porous PTFE membranes, which allows biocompatibility of the PTFE materials to be increased.

Moreover, the expanded polytetrafluoroethylene artificial blood vessels and the like, whose surface were modified according to the present invention, have a hydrophilic surface changed from a hydrophobic surface, a remarkably reduced fluorine content, and increased cell adhesion.

Furthermore, the surface-modified ePTFE artificial blood vessels may be coated with a biodegradable polymer, such as polylactide, etc. Also, surface-modified ePTFE films exhibit remarkably increased permeability.

In addition, the polytetrafluoroethylene materials, whose biocompatibility was improved according to the present invention, are used as a material of membranes, blood-contacting films, artificial blood vessels, stent-bound artificial blood vessels, artificial hearts, artificial valves, artificial heart-lung machines, artificial kidneys, venous catheters, and the like.

1. A method for chemically modifying the surface of polytetrafluoroethylene materials, which comprises the steps of:
mixing a hydrogen compound selected from sodium hydroborate and sodium hydride, a cyclic compound selected from anthraquinone or derivatives thereof, and an organic solvent selected from anhydrous dichloromethane, dimethylformamide and dimethylsulfoxide, so a to produce a reactant solution;
adding polytetrafluoroethylene materials to the reactant solution;
applying heat or ultraviolet energy to the mixture containing the polytetrafluoroethylene materials under the atmosphere of inert gas and reacting the mixture at a temperature of 30-300° C. for 1-72 hours, thereby removing fluorine from the surface of the polytetrafluoroethylene materials by electron exchange reaction;
removing the remaining reactants from the polytetrafluoroethylene materials; and
drying the polytetrafluoroethylene materials.

2. The method of claim 1, wherein the polytetrafluoroethylene materials is selected from the group consisting of expanded polytetrafluoroethylene artificial blood vessels, polytetrafluoroethylene films, and porous polytetrafluoroethylene membranes.

3. Expanded polytetrafluoroethylene artificial blood vessels, polytetrafluoroethylene films, or porous polytetrafluoroethylene membranes, which have a surface modified according to the method of claim 2.

4. Polytetrafluoroethylene materials, which have a surface modified according to the method of claim 1 and are used as materials of wastewater-filtering membranes, blood-contacting films, stent-bound ePTFE artificial blood vessels, prostheses for noise correction, hemodialyzers, artificial hearts, artificial valves, artificial heart-lung machine, and venous catheters.

5. An apparatus for modifying the surface of polytetrafluoroethylene materials, which comprises:
a condenser 10 having a port located at the outside thereof, the port being connected to a hose such that water 14 can be circulated;
a reactor 11 connected to the condenser 10;
a gas line 16, which connected to the upper portion of the condenser 11 and through which inert gas 15 flows;
a bubbler 20 connected to the gas line 16 and containing oil 21;
a mantle 12 disposed around the reactor 11 and serving to provide surface modification energy by electrical heating or ultraviolet; and
a stirrer 13 disposed at the lower portion of the mantle 12 while supporting the mantle 12.
